(19) United States
(12) Patent Application Publication
(10) Pub. No.: US 2016/0147200 A1
(43) Pub. Date: May 26, 2016

(54) METHOD AND DEVICE FOR SETTING UP TASK

(71) Applicant: Xiaomi Inc., Beijing (CN)

(72) Inventors: Bin Zhang, Beijing (CN); Jun Su, Beijing (CN); Yongfeng Xia, Beijing (CN); Yunlin Hu, Beijing (CN); Yang Wang, Beijing (CN); Hao Chen, Beijing (CN)

(21) Appl. No.: 14/835,728

(22) Filed: Aug. 26, 2015

Related U.S. Application Data
(63) Continuation of application No. PCT/CN2015/077826, filed on Apr. 29, 2015.

(30) Foreign Application Priority Data
Nov. 21, 2014 (CN) 201410674070.5

(51) Int. Cl. G05B 13/02; H04L 12/28

(52) U.S. Cl. CPC G05B 13/026; H04L 12/2816

(57) ABSTRACT

A method and a device for setting up a task are disclosed herein, which belong to the field of computer technologies. The method for setting up a task includes: acquiring an operation history of a user for operating a household appliance; detecting whether a habitual task exists according to the operation history, wherein the habitual task is a task corresponding to an operation which has been received at a fixed time for more than a predetermined number of times; and if the habitual task exists, setting up a habitual task item corresponding to the fixed time, wherein the habitual task item is a task item for the household appliance to run the habitual task at the fixed time.

### CROSS-REFERENCE TO RELATED APPLICATIONS

This application is a Continuation application of International Application No. PCT/CN2015/077826, filed with the State Intellectual Property Office of P. R. China on Apr. 29, 2015, is based upon and claims priority to Chinese Patent Application No. 201410674070.5, filed on Nov. 21, 2014, the entire contents of which are incorporated herein by reference.

### TECHNICAL FIELD

The present disclosure relates to the field of computer technologies, and more particularly, to a method and a device for setting up a task.

### BACKGROUND

Household appliances such as air conditioners, air purifiers and water dispensers are the most common household appliances in a household.

During the process of using the household appliances, a user may operate the household appliances to run corresponding tasks. For instance, the user is accustomed to drink a cup of hot water before sleep, therefore, the user may turn on the water dispenser to boil water.

In the process of achieving the present disclosure, it is found that the related art at least has the following defects: when the user forgets to operate the household appliances due to some affairs, the household appliances will not run any task, which leads to a problem that the household appliances cannot provide timely services to the user.

### SUMMARY

The present disclosure provides a method and a device for setting up a task. The technical solutions are as follows.

According to a first aspect of embodiments of the present disclosure, there is provided a method for setting up a task, including: acquiring an operation history of a user for operating a household appliance; detecting whether a habitual task exists according to the operation history, wherein the habitual task is a task corresponding to an operation which has been received at a fixed time for more than a predetermined number of times; and if the habitual task exists, setting up a habitual task item corresponding to the fixed time, wherein the habitual task item is a task item for the household appliance to run the habitual task at the fixed time.

According to a second aspect of embodiments of the present disclosure, there is provided a device for setting up a task, including: a processor; and a memory for storing instructions executable by the processor; wherein the processor is configured to perform: acquiring a operation history of a user for operating a household appliance; detecting whether a habitual task exists according to the operation history, wherein the habitual task is a task corresponding to an operation which has been received at a fixed time for more than a predetermined number of times; and if the habitual task exists, setting up a habitual task item corresponding to the fixed time, wherein the habitual task item is a task item for the household appliance to run the habitual task at the fixed time.

According to a third aspect of the embodiments of the present disclosure, there is provided a non-transitory readable storage medium comprising instructions, executable by a processor in a device, for performing a method for setting up a task, the method comprising: acquiring an operation history of a user for operating a household appliance; detecting whether a habitual task exists according to the operation history, wherein the habitual task is a task corresponding to an operation which has been received at a fixed time for more than a predetermined number of times; and if the habitual task exists, setting up a habitual task item corresponding to the fixed time, wherein the habitual task item is a task item for the household appliance to run the habitual task at the fixed time.

Accordingly, the present disclosure solves the problem in the related art that the household appliance may not provide services for the user in time and achieves the effects that the household appliance may run the habitual task at the fixed time, so that the household appliance can always provide services required by the user.

It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a schematic diagram of an implementation scenario related to a method for setting up a task, according to some exemplary embodiments.

FIG. 2 is a flow chart of a method for setting up a task, according to an exemplary embodiment.

FIG. 3A is a flow chart of a method for setting up a task, according to another exemplary embodiment.

FIG. 3B is a display schematic diagram of a terminal device for displaying first query information, according to an exemplary embodiment.

FIG. 3C is a display schematic diagram of a terminal device for displaying second query information, according to an exemplary embodiment.

FIG. 3D is a display schematic diagram of a terminal device when sending a trigger signal to a household appliance, according to an exemplary embodiment.

FIG. 3E is a display schematic diagram of a terminal device before feeding back the first feedback information to a mobile household appliance, according to an exemplary embodiment.

FIG. 4 is a flow chart of a method for setting up a task, according to another exemplary embodiment.

FIG. 5 is a flow chart of a method for setting up a task, according to another exemplary embodiment.

FIG. 6 is a block diagram of an apparatus for setting up a task, according to an exemplary embodiment.

FIG. 7 is a block diagram of an apparatus for setting up a task, according to another exemplary embodiment.

FIG. 8 is a block diagram of a terminal device for setting up a task, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with some aspects related to the invention as recited in the appended claims.

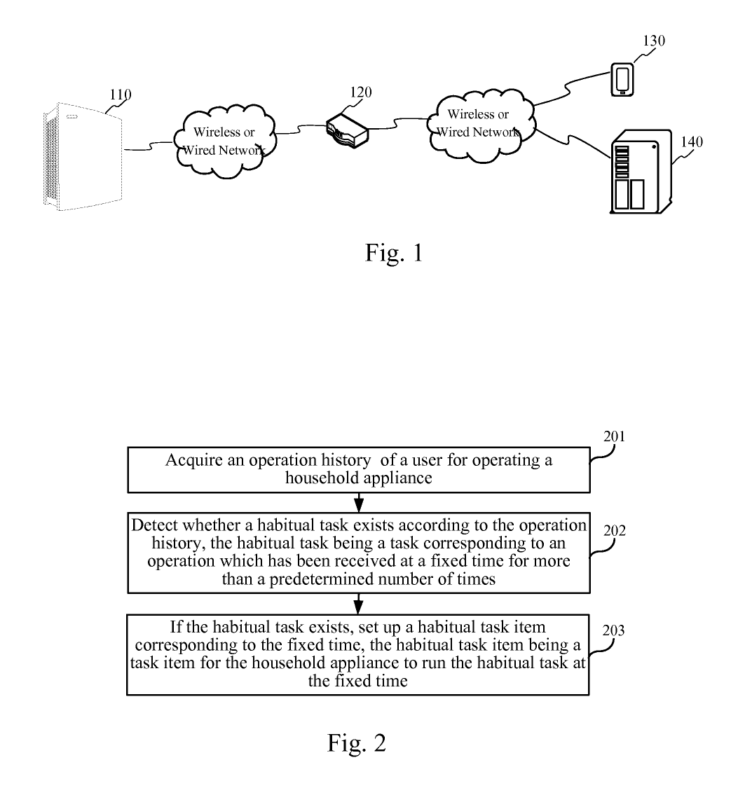

FIG. 1 shows a schematic diagram of an implementation scenario related to a method for setting up a task according to each exemplary embodiment of the present disclosure. As shown in FIG. 1, the implementation scenario may include: a household appliance 110, a household gateway device 120, a terminal device 130 and a server 140.

The household appliance 110 may be connected with the household gateway device 120 through a wired or wireless network, and its connection with the terminal device 130 and the server 140 may be realized through the household gateway device 120. During actual implementations, the household appliance 110 may be an air purifier, an air quality detector, a water dispenser or an air conditioner. The household gateway device 120 may be a router.

A client APP is installed in the terminal device 130, wherein the client APP is provided by a service provider, and a user may control the household appliance 110 through the client APP. During actual implementation, when the terminal device 130 and the household appliance 110 are in the same LAN, the terminal device 130 may find the household appliance 110 through the household gateway device 120, so as to establish a binding relationship with the household appliance 110. The household appliance 110 may establish a binding relationship with one or more terminal devices 130.

The server 140 is a background server provided by the service provider, which is configured to be combined with the client APP in the terminal device 130 so as to provide the user with the service provided by the service provider.

FIG. 2 is a flow chart of a method for setting up a task, according to an exemplary embodiment. In the embodiment, the method for setting up a task is applied in an implementation scenario as shown in FIG. 1 for illustration. As shown in FIG. 2, the method for setting up a task may include the following steps.

In step 201, an operation history of a user for operating a household appliance is acquired.

In step 202, whether a habitual task exists is detected according to the operation history, the habitual task being a task corresponding to an operation which has been received at a fixed time for more than a predetermined number of times.

In step 203, if the habitual task exists, a habitual task item is set up corresponding to the fixed time, the habitual task item being a task item for the household appliance to run the habitual task at the fixed time.

In conclusion, through acquiring the operation history of the user for operating the household appliance, detecting whether the habitual task exists according to the operation history, the habitual task being the task corresponding to the operation which has been received at a fixed time for more than a predetermined number of times; and if the habitual task exists, setting up the habitual task item corresponding to the fixed time, the habitual task item being the task item for the household appliance to run the habitual task at the fixed time; the method for setting up a task provided by the present disclosure solves the problem in the related art that the household appliance may not provide timely services for the user; and achieves the effects that the household appliance may run the habitual task at the fixed time, so that the household appliance can always provide services required by the user.

The method for setting up a task disclosed in the foregoing embodiments may either be used in the household appliance 110 as shown in FIG. 1, or used in the household gateway device 120 or the terminal device 130 or the server 140, and the implementation manners of the household gateway device 120 and the server 140 are similar; therefore, the following descriptions will introduce the method for setting up a task by applying it in the household appliance 110, the household gateway device 120 and the terminal device 130 respectively through three embodiments.

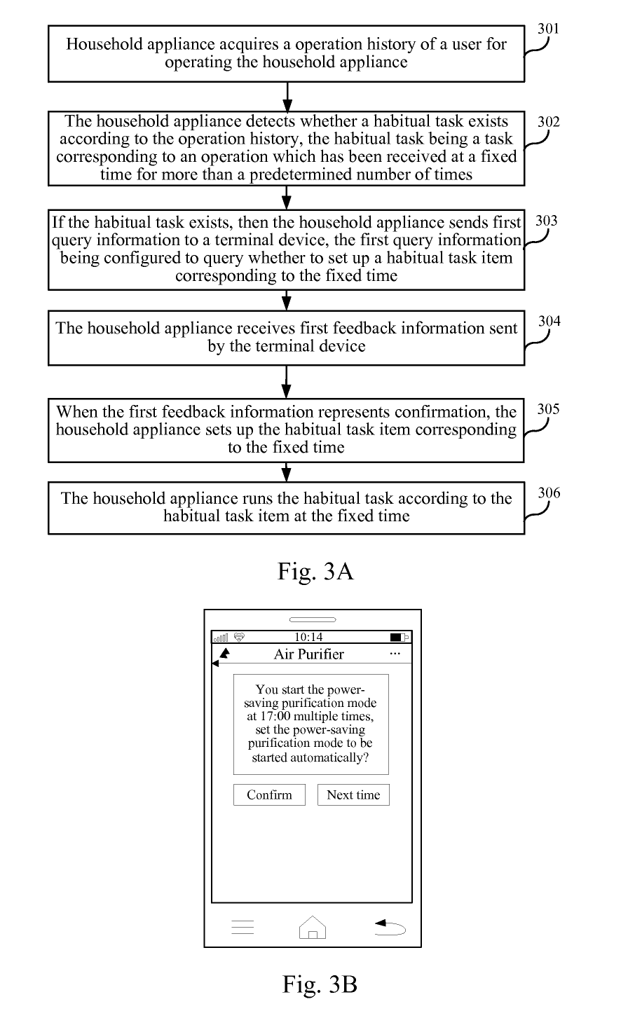

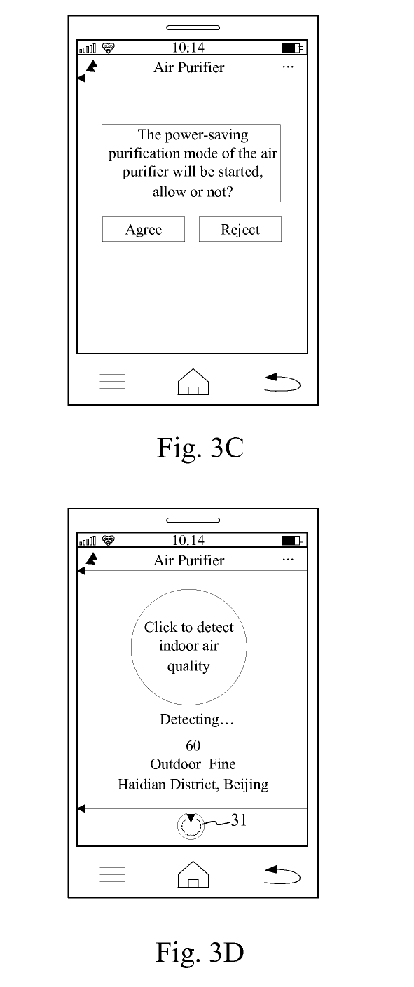

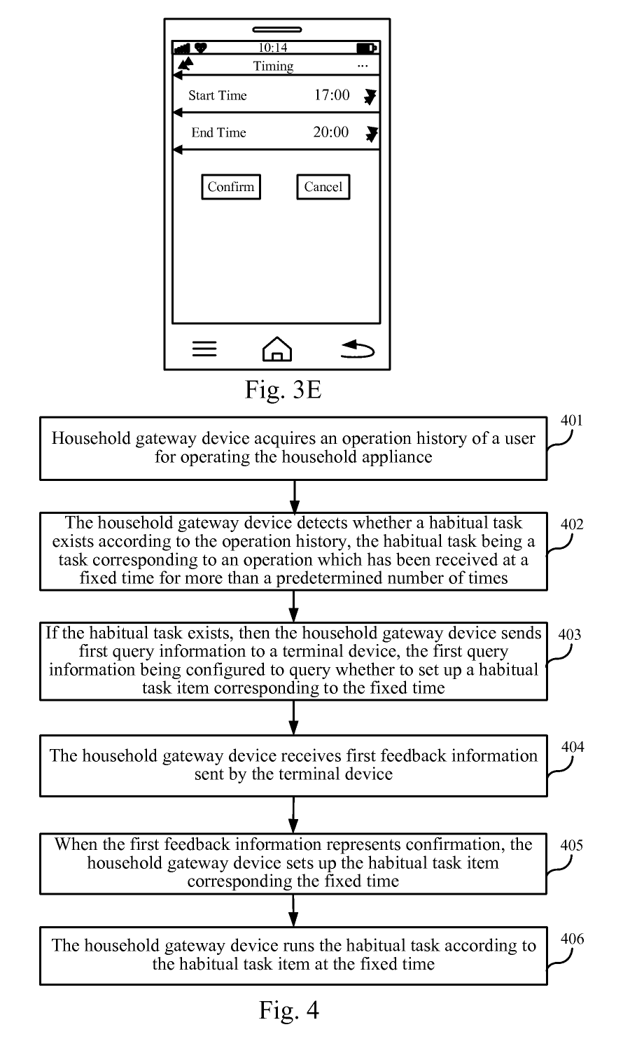

FIG. 3A is a flow chart of a method for setting up a task, according to an exemplary embodiment. In the embodiment, the method for setting up a task is applied in the household appliance 110 as shown in FIG. 1 for illustration. As shown in FIG. 3A, the method for setting up a task may include the following steps.

In step 301, a household appliance acquires an operation history of a user for operating the household appliance.

When the user operates the household appliance, the household appliance may record and store the operation record of the user, wherein the operation record may include an operation time and an operation type.

For instance, taking the household appliance as an air purifier for example, when the user operates the air purifier to switch on a power-saving purification mode at “17:00”, the operation recorded by the air purifier includes the operation time (17:00) and the operation type (switching on the power-saving purification mode).

Thereafter, when the household appliance needs to use each operation record, the household appliance may directly read the operation history stored locally.

In step 302, the household appliance detects whether a habitual task exists according to the operation history, the habitual task being a task corresponding to an operation which has been received at a fixed time for more than a predetermined number of times.

During actual implementation, the method for the household appliance to detect whether the habitual task exists according to the operation history may include the following two types.

The first type is that the household appliance analyzes the acquired operation history, and detects whether the habitual task exists according to the analysis result.

The household appliance may directly analyze the acquired operation history, detect whether such an operation exists in the analysis result that the number of times of the same operation received at a fixed time reaches a predetermined number of times, and then determine the task corresponding to the operation as the habitual task if the detection result shows that the operation exists.

The household appliance may analyze the operation history within a unit time period, counts the number of times of the same operation received within the unit time period, and detect whether the counted number of times reaches the predetermined number of times. If the detection result shows that the number of times reaches the predetermined number of times, then the household appliance may determine the task corresponding to the operation as the habitual task. The unit time period may be one day, one week, one month, two month, and the like.

For instance, taking the predetermined number of times being four times and the unit time period being one week for example, the household appliance, after analyzing each operation history, finds that the user switches on the power-saving purification mode of the air purifier at “17:00” in five days within the past week, then the household appliance may detect and obtain that the number of times of switching on the air purifier received at 17:00 reaches the predetermined number of times (four times). Thus, the household appliance may determine the task of switching on the power-saving purification mode of the air purifier at 17:00 to be the habitual task.

Similarly, if an operation record of switching off the air purifier at 20:00 in every day exists in the operation record, then the household appliance may also determine the task of closing the air purifier at 20:00 in every day to be the habitual task.

The second type is that the household appliance sends the operation history to the server; the server analyzes the operation history, feeds back an analysis result to the household appliance, and the household appliance detects whether the habitual task exists according to the received analysis result.

As another probable implementation manner, the household appliance may also send the operation history to the server. The server receives the operation history, analyzes the operation history, and feeds back an analysis result to the household appliance. Accordingly, the household appliance receives the analysis result fed back by the server, and detects whether the habitual task exists according to the analysis result. This is similar to the foregoing implementation manner, which will not be elaborated herein in the embodiment.

In step 303, if the habitual task exists, then the household appliance sends first query information to a terminal device, the first query information being configured to query whether to set up a habitual task item corresponding to the fixed time.

If the detection result of the household appliance is that the habitual task exists, then the household appliance may send the first query information to the terminal device, wherein the first query information is configured to query whether to set up the habitual task item corresponding to the fixed time.

Accordingly, the terminal device may receive the first query information, and display the received first query information.

After viewing the first query information displayed by the terminal device, the user may make a response, and operate the terminal device to send first feedback information to the household appliance. For instance, when the user agrees to set up the habitual task item corresponding to the fixed time, the user may operate the terminal device to feed back feedback information representing confirmation to the household appliance; while when the user disagrees to set up the habitual task item corresponding to the fixed time, the user may operate the terminal device to feed back feedback information representing rejection to the household appliance.

For instance, referring to FIG. 3B, the terminal device may display the first query information with the content “You start the power-saving purification mode at 17:00 multiple times, set the power-saving purification mode to be started automatically?” When the user agrees, the user may click “confirm”. When the user disagrees, the user may click “next time”, which will not be limited in the embodiment.

In step 304, the household appliance receives first feedback information sent by the terminal device.

The household appliance may correspondingly receive the first feedback information sent by the terminal device.

In step 305, when the first feedback information represents confirmation, the household appliance sets up the habitual task item corresponding to the fixed time.

If the first feedback information received by the household appliance represents confirmation, then the household appliance may set up the habitual task item corresponding to the fixed time, wherein the habitual task item is a task item for running the habitual task at the fixed time.

If the first feedback information received by the household appliance represents rejection, then the household appliance may end the flow.

In step 306, the household appliance runs the habitual task according to the habitual task item at the fixed time.

After the household appliance sets up the habitual task item corresponding to the fixed time, the household appliance may run the habitual task according to the habitual task item set in advance at the fixed time.

During actual implementation, there are two implementation manners for the household appliance to run the habitual task according to the habitual task item.

For the first implementation manner, the step may include the following.

Firstly, it is detected whether the household appliance has already run the habitual task at the fixed time.

The household appliance may detect whether it has already run the habitual task at the fixed time.

In the embodiment, whether the household appliance has already run the habitual task includes that the household appliance has finished running the habitual task and/or the household appliance is running the habitual task.

Secondly, the habitual task is run if the household appliance has not run the habitual task.

If the household appliance has not run the habitual task, then the household appliance may run the habitual task.

If the household appliance has already run the habitual task, then the household appliance may end this flow, which will not be limited in the embodiment.

In the second implementation manner, the step may include the following.

Firstly, at the fixed time, second query information is sent to the terminal device, the second query information being configured to query whether to allow the household appliance running the habitual task.

As an alternative implementation manner, at the fixed time, the household appliance may send the second query information to the terminal device, wherein the second query information is configured to query whether to allow the household appliance running the habitual task.

The terminal device may correspondingly receive the second query information, and display the received second query information. After that, when the user agrees the household appliance to run the habitual task, the user may operate the terminal device to send second feedback information representing allowance of running to the household appliance; and when the user disagrees the household appliance to run the habitual task, the user may operate the terminal device to send second feedback information representing disallowance of running to the household appliance.

For instance, the second query information sent by the air purifier is “The power-saving purification mode of the air purifier will be started, allow or not?”, then the terminal device may display an interface as shown in FIG. 3C. After that, when the user agrees to start, the user may click “Agree”; and when the user disagrees to set, the user may click “Reject”.

Secondly, the second feedback information sent by the terminal device is received.

The household appliance may correspondingly receive the second feedback information sent by the terminal device.

Thirdly, when the second feedback information represents allowance of running, the habitual task is run.

When the second feedback information received by the household appliance represents information of allowing running, it indicates that the user allows the household appliance running the habitual task, so the household appliance may run the habitual task.

On the contrary, when the second feedback information received by the household appliance represents information of disallowing running, it indicates that the user does not want the household appliance to run the habitual task, so the household appliance may not run the habitual task and end this flow.

It should be noted that the embodiment only takes the example of using one of the foregoing probable implementation manner to run the habitual task. During actual implementation, the household appliance may use the foregoing two probable implementation manners at the same time, or the household appliance may automatically run the habitual task at the fixed time, which will not be limited in the embodiment.

It should be also noted that before step 303, the household appliance may receive a trigger signal sent by the terminal device, wherein the trigger signal may be a signal sent when the user turns on the household appliance through the client APP in the terminal device.

For instance, referring to FIG. 3D, when the user clicks a start-up control 31 in FIG. 3D, the terminal device may send a trigger signal to the household appliance. After that, the household appliance, after finishing running the step 301 and the step 302, sends the first query information to the terminal device. That is, the terminal device may correspondingly display the interface as shown in FIG. 3B, which will not be limited in the embodiment.

It should be also noted that when the habitual task detected and obtained by the household appliance is a task within a fixed time period, for instance, the habitual task is “starting the power-saving purification mode between 17:00 and 20:00”, then after the terminal device displays a display interface as shown FIG. 3B and receives a confirmation signal exerted by the user, the terminal device may jump to a display interface as shown in FIG. 3E. The user sets a time period corresponding to the habitual task in the display interface, and sends the first feedback information to the household appliance after completing setting of the time period, which will not be limited in the embodiment.

In conclusion, through acquiring the operation history of the user for operating the household appliance, detecting whether the habitual task exists according to the operation history, the habitual task being the task corresponding to the operation which has been received at a fixed time for more than a predetermined number of times; and if the habitual task exists, setting up the habitual task item corresponding to the fixed time, the habitual task item being the task item for the household appliance to run the habitual task at the fixed time; the method for setting up a task provided by the present disclosure solves the problem in the related art that the household appliance may not provide timely services for the user; and achieves the effects that the household appliance may run the habitual task at the fixed time, so that the household appliance can always provide services required by the user.

According to the embodiment, the first query information is sent to the terminal device, and only when the received feedback information represents confirmation, i.e., the user agrees to set up the habitual task item corresponding to the fixed time, the household appliance may set up the habitual task item corresponding to the fixed time; therefore, the operation of the household appliance better meets the expectation of the user, thus improving the user experience.

Meanwhile, after setting up the habitual task item corresponding to the fixed time, the household appliance may run the habitual task according to the habitual task item, thus solving the problem in the related art that when the user forgets to operate the household appliance, the household appliance will not run any task.

Furthermore, according to the embodiment, before running the habitual task, the user is queried whether the user allows running or not, and only when the user allows running, the habitual task is run, thus further improving the user experience.

It should be additionally noted that in the foregoing embodiments, the method for setting up a task may also include the following.

Firstly, the household appliance acquires preset information, the preset information including at least one of air quality information of an environment in which the household appliance is located, a light intensity of the environment in which the household appliance is located within a first predetermined time period, a sound intensity of the environment in which the household appliance is located within a second predetermined time period and the last using time of the household appliance and/or other household appliance in the same LAN as that of the household appliance.

When the preset information includes the air quality information, if the household appliance is a device capable of detecting the air quality (for instance, an air purifier or an air quality detector), then the household appliance may directly detect the air quality of the environment in which the household appliance is located, and acquire the air quality information; and if the household appliance is a device capable of detecting the air quality, the household appliance may acquire the air quality information from other device capable of detecting the air quality in the same LAN through a household gateway device.

When the preset information includes the light intensity of the environment in which the household appliance is located within the first predetermined time period, if the household appliance is capable of acquiring light intensity, then the household appliance may acquire the light intensity of the environment in which the household appliance is located within the first predetermined time period, and store the acquired light intensity. When the light intensity needs to be used later, the stored light intensity may be read. For instance, the household appliance directly acquires the light intensity of the environment in which the household appliance is located at “17:00-20:00”. If the household appliance is not capable of acquiring the light intensity, the household appliance may acquire, through the household gateway device, the light intensity of the environment in which the household appliance is located from other household appliance that is capable of acquiring the light intensity and is connected with the household gateway device, herein the light intensity is acquired in advance by other household appliance that is capable of acquiring the light intensity, which will not be limited in the embodiment.

When the preset information includes the sound intensity of the environment in which the household appliance is located within a second predetermined time period, if the household appliance is capable of acquiring the sound intensity, the household appliance may directly acquire the sound intensity of the environment in which the household appliance is located within the second predetermined time, for instance, acquire the sound intensity of the environment in which the household appliance is located between “19:30 and 21:30”. If the household appliance is not capable of acquiring the sound intensity, the household appliance may acquire, through the household gateway device, the sound intensity of the environment in which the household appliance is located from other household appliance that is capable of acquiring the sound intensity and is connected with the household gateway device, herein the sound intensity is acquired in advance by other household appliance that is capable of acquiring the sound intensity, which will not be limited in the embodiment. The second predetermined time period and the first predetermined time period may either be identical time period, or be different time periods, which will not be limited in the embodiment.

When the preset information includes a last using time of the household appliance and/or other household appliance in the same LAN as that of the household appliance, the household appliance may acquire the last using time of itself, or the last using time of another household appliance in the same LAN as that of the household appliance through the household gateway device, or both the last using time of itself and the last using time of another household appliance in the same LAN as that of the household appliance.

Secondly, the household appliance detects whether the preset information satisfies a preset condition, the preset condition including at least one of that the air quality information representing that the air quality being poorer than a preset air quality, the light intensity being less than a preset light intensity, the sound intensity being less than a preset intensity, and the last using time being a time before a predetermined duration.

After acquiring the preset information, the household appliance may detect whether the preset information satisfies the preset condition.

When the preset information includes the air quality information, the household appliance may detect whether the air quality represented by the air quality information is poorer than the preset air quality. When the detection result shows that the air quality is poorer than the preset air quality, the household appliance may know that the environment in which the household appliance is located may not be clean for a long time, and the user may not be at home for a long time, and so the preset information satisfies the corresponding condition. However, if the detection result shows that the air quality is not poorer than the preset air quality, it indicates that the surrounding air quality is better, and the user may frequently do cleaning, and so the preset information does not satisfy the corresponding condition.

When the preset information includes the light intensity of the environment in which the household appliance is located within the first predetermined time period, the household appliance may detect whether the acquired light intensity is less than the preset light intensity. When the first predetermined time period is a certain time period at night, and the detection result shows that the light intensity is less than the preset light intensity, it indicates that the user may possibly not turn on a lighting household appliance such as an electric lamp or a TV within the first predetermined time period. That is, the user may possibly not return home, and the preset information satisfies the corresponding condition. When the detection result shows that the light intensity is not less than the preset light intensity, it indicates that the user normally turns on the lighting household appliance within the first predetermined time period. That is, the user may possibly return home, and the preset information does not satisfy the corresponding condition.

When the preset information includes the sound intensity of the environment in which the household appliance is located within the second predetermined time period, the household appliance may detect whether the acquired sound intensity is less than the preset intensity. When the second predetermined time period is a certain time period at night, and the detection result shows that the sound intensity is less than the preset intensity, it indicates that the user may possibly not return home, and the preset information satisfies the corresponding condition. When the detection result shows that the sound intensity is not less than the preset intensity, it indicates that the user may possibly return home within the second predetermined time period, and the preset information does not satisfy the corresponding condition.

When the preset information includes the last using time, the household appliance may detect whether the last using time is a time before a predetermined duration. When the detection result shows that the last using time is a time before the predetermined duration, then the household appliance may know that the household appliance has not be used for a long time, and the user may possibly not return home for a long time, and so the preset information satisfies the corresponding condition. If the detection result shows that the usage moment is not a moment before the predetermined duration, it indicates that the household electrical appliance has been used recently, i.e., the user normally uses the household appliance, and so the preset information does not satisfy the corresponding condition.

It should be illustrated that the embodiment only takes the foregoing four types of the preset information as an example. In actual implementation, the preset information may also include other information, which will not be limited in the embodiment. Moreover, when the preset information includes two or more than two types of information, it may be set that only when the two or more than two types of information satisfy the corresponding condition at the same time, the preset information satisfies the preset condition. Alternatively, it may be set that when the number of the two or more than two types of the information satisfying the corresponding condition reaches a predetermined number, the preset information satisfies the preset condition.

Thirdly, if the preset information satisfies the preset condition, then the household appliance turns off the household appliance and other household appliance in the same LAN as that of the household appliance through the household gateway device.

If the detection result of the household appliance is that the preset information satisfies the preset condition, then it indicates that the user may possibly go out for a long time. Then, for the purpose of safety use of electricity and energy saving, the household appliance may turn off the household appliance and other household appliances in the same LAN as that of the household appliance through the household gateway device.

In actual implementation, before the household appliance turns off itself and other household appliance in the same LAN as that of the household appliance, the household appliance may also send third query information to the terminal device through the household gateway device, the third query information being configured to query whether or not to turn off the household appliance and other household appliance in the same LAN as that of the household appliance. If the feedback information sent by the terminal device represents allowance of turning off, each household appliance is turned off. In this way, the operation of each household appliance better meets the using habit of the user, thus improving the user experience.

FIG. 4 is a flow chart of a method for setting up a task, according to an exemplary embodiment. In the embodiment, the method for setting up a task is applied in the household gateway device 120 as shown in FIG. 1 for illustration. As shown in FIG. 4, the method for setting up a task may include the following steps.

In step 401, a household gateway device acquires an operation history of a user for operating the household appliance.

When the user operates the household appliance, the household appliance may record the operation of the user and store the recorded operation; or, store the recorded operation into the household gateway device; or, send the recorded operation to a terminal device through the household gateway device; or, send the recorded operation to a server through the household gateway device.

After that, when the household gateway device needs to use the operation history, the household gateway device may acquire the operation history.

In actual implementation, the manner for the household gateway device to acquire the operation history may include at least one of the following manners.

The first manner is that when the operation history is stored in the household gateway device, the household gateway device may directly read the pre-stored operation history.

The second manner is that when the operation history is stored in the household appliance, the household gateway device may send a first acquisition request of acquiring the operation history to the household appliance; and the household appliance sends the operation history to the household gateway device after receiving the first acquisition request.

The third manner is that when the operation history is stored in the server, the household gateway device may send a second acquisition request of acquiring the operation history to the server; and the server sends the operation history to the household gateway device after receiving the second acquisition request.

In step 402, the household gateway device detects whether a habitual task exists according to the operation history, the habitual task being a task corresponding to an operation which has been received at a fixed time for more than a predetermined number of times.

After acquiring the operation history, the household gateway device may detect whether the habitual task exists according to the operation history. This is similar to the detection manner of the household appliance for detecting whether the habitual task exists, which will not be elaborated herein in the embodiment.

In step 403, if the habitual task exists, then the household gateway device sends first query information to the terminal device, the first query information being configured to query whether or not to set up a habitual task item corresponding to the fixed time.

If the detection result of the household gateway device is that the habitual task exists, then the household gateway device may send the first query information to the terminal device, wherein the first query information is configured to query whether or not to set up the habitual task item corresponding to the fixed time.

Accordingly, the terminal device may receive the first query information, and display the received first query information.

After viewing the first query information displayed by the terminal device, the user may make a response, and operate the terminal device to send first feedback information to the household gateway device. When the user agrees to set up the habitual task item corresponding to the fixed time, the user may operate the terminal device to feed back feedback information that represents confirmation to the household gateway device; and when the user does not agree to set up the habitual task item corresponding to the fixed time, the user may operate the terminal device to feed back feedback information that represents rejection to the household gateway device.

This is similar to the step 303 in the foregoing embodiment, which will not be elaborated herein in the embodiment.

In step 404, the household gateway device receives the first feedback information sent by the terminal device.

The household gateway device may correspondingly receive the first feedback information sent by the terminal device.

In step 405, when the first feedback information represents confirmation, the household gateway device sets up the habitual task item corresponding to the fixed time.

If the first feedback information received by the household gateway device represents confirmation, then the household gateway device may set up the habitual task item corresponding to the fixed time, wherein the habitual task item is to run the task item of the habitual task at the fixed time.

If the first feedback information received by the household gateway device represents rejection, then the household gateway device may end the flow.

In step 406, the household gateway device runs the habitual task according to the habitual task item at the fixed time.

At the fixed time, the household gateway device may send a control instruction of controlling the household appliance to run the habitual task to the household appliance. Accordingly, the household appliance may receive the control instruction, and run the habitual task after receiving the control instruction.

It should be illustrated that the present embodiment only takes the household gateway device sending the control instruction to the household appliance at the fixed time as an example. In actual implementation, the household gateway device may also directly send the control instruction carrying the fixed time to the household appliance without waiting for the arrival of the fixed time after setting up the habitual task item, which will not be limited in the embodiment.

In conclusion, through acquiring the operation history of the user for operating the household appliance, detecting whether the habitual task exists according to the operation history, the habitual task being the task corresponding to the operation which has been received at a fixed time for more than a predetermined number of times; and if the habitual task exists, setting up the habitual task item corresponding to the fixed time, the habitual task item being the task item for the household appliance to run the habitual task at the fixed time; the method for setting up a task provided by the present disclosure solves the problem in the related art that the household appliance may not provide timely services for the user; and achieves the effects that the household appliance may run the habitual task at the fixed time, so that the household appliance can always provide services required by the user.

According to the present embodiment, the first query information is sent to the terminal device, and only when the received feedback information represents confirmation, i.e., the user agrees to set up the habitual task item corresponding to the fixed time, the household gateway device may set up the habitual task item corresponding to the fixed time; therefore, the operation of the household appliance better meets the expectation of the user, thus improving the user experience.

Meanwhile, after setting up the habitual task item, when the fixed time arrives, the household gateway device may control the household appliance to run the habitual task, thus solving the problem in the related art that when the user forgets to operate the household appliance, the household appliance will not run any task.

It should be additionally noted that in the foregoing embodiment, the method for setting up a task may also include the following steps.

Firstly, the household gateway device acquires preset information, the preset information including at least one of air quality information of an environment in which the household appliance is located, a light intensity of the environment in which the household appliance is located within a first predetermined time period, a sound intensity of the environment in which the household appliance is located within a second predetermined time period and the last using time of the household appliance and/or other household appliance in the same LAN as that of the household appliance.

When the preset information includes the air quality information, the household gateway device may acquire the air quality information from the household appliance capable of detecting the air quality and is connected with the household gateway device. The air quality information is information acquired in advance by the household appliance capable of detecting the air quality.

When the preset information includes the light intensity of the environment in which the household appliance is located within the first predetermined time period, the household gateway device may acquire the light intensity of the environment in which the household appliance is located within the first predetermined time period from the household appliance capable of acquiring the light intensity and is connected with the household gateway device. The light intensity is the information acquired and stored by the household appliance capable of acquiring the light intensity within the first time period.

When the preset information includes the sound intensity of the environment in which the household appliance is located within the second predetermined time period, the household gateway device may acquire the sound intensity of the environment in which the household appliance is located within the second predetermined time period from the household appliance that capable of acquiring the sound intensity and is connected with the household gateway device. The sound intensity is the information acquired and stored by the household appliance capable of acquiring the sound intensity within the second time period. The second predetermined time period and the first predetermined time period may either be identical time period, or different time periods, which will not be limited in the embodiment.

When the preset information includes the last using time of the household appliance and/or other household appliance in the same LAN as that of the household appliance, the household gateway device may acquire the last using time of each household appliance connected with the household gateway device.

Secondly, the household gateway device detects whether the preset information satisfies a preset condition, the preset condition including at least one of the air quality information representing that the air quality being poorer than a preset air quality, the light intensity being less than a preset light intensity, the sound intensity being less than a preset intensity, and the last using time being a time before a predetermined duration.

After acquiring the preset information, the household gateway device may detect whether the preset information satisfies the preset condition. This detection method is similar to the corresponding steps in the foregoing embodiment, which will not be elaborated herein in the embodiment.

It should be illustrated that the embodiment only takes the foregoing four types of the preset information as an example. In actual implementation, the preset information may also include other information, which will not be limited in the embodiment. Moreover, when the preset information includes two or more than two types of information, it may be set that only when the two or more than two types of information satisfy the corresponding condition at the same time, the preset information satisfies the preset condition. Alternatively, it may be set that when the number of the two or more than two types of the information satisfying the conditions reaches a predetermined number, the preset information satisfies the preset condition.

Thirdly, if the preset information satisfies the preset condition, then the household gateway device turns off the household appliance and other household appliance in the same LAN as that of the household appliance.

If the detection result of the household gateway device shows that the preset information satisfies the preset condition, it indicates that the user may possibly go out. Then, for the purpose of safety use of electricity and energy saving, the household gateway device may turn off each household appliance connected with the household gateway device.

In actual implementation, before turning off each household appliance connected with the household gateway device, the household gateway device may also send third query information to the terminal device, the third query information being configured to query whether or not to turn off each household appliance; if the feedback information sent by the terminal device represents allowance of turning off, then the household gateway device turns off each household appliance connected with the household gateway device. In this way, the operation of each household appliance better meets the using habit of the user, thus improving the user experience.

It should be illustrated that when the method is applied in the server, the implementation manner thereof is similar to that of the method applied in the household gateway device; therefore, it will not be elaborated herein in the embodiment.

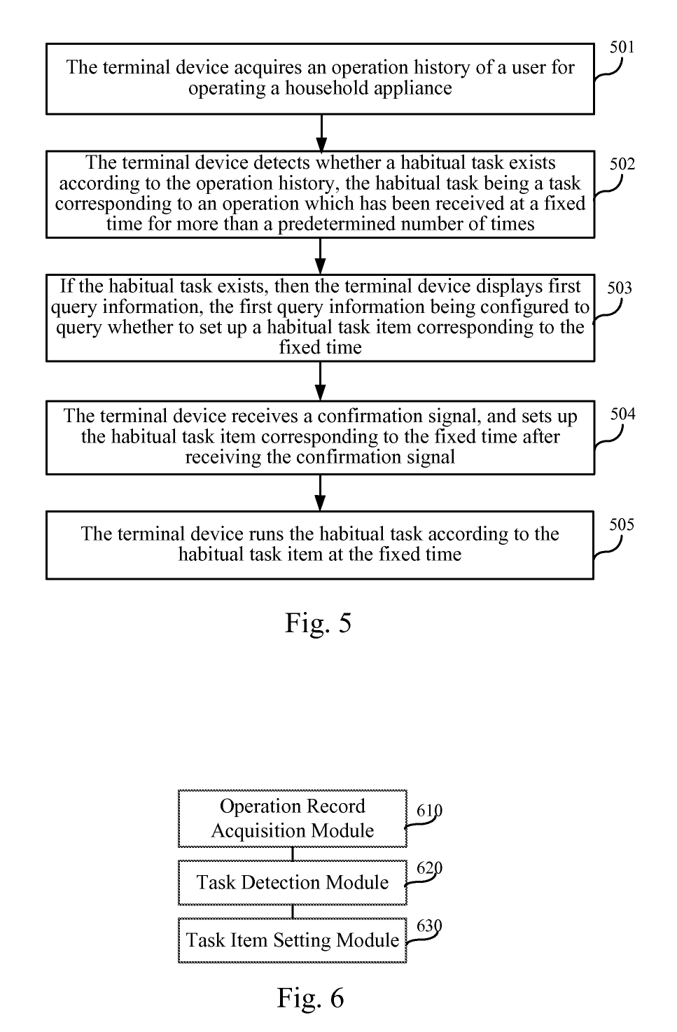

FIG. 5 is a flow chart of a method for setting up a task, according to an exemplary embodiment. In the embodiment, the method for setting up a task is applied in the terminal device 130 as shown in FIG. 1 for illustration. As shown in FIG. 5, the method for setting up a task may include the following steps.

In step 501, the terminal device acquires an operation history of a user for operating a household appliance.

When the user operates the household appliance, the household appliance may record the operation of the user and store the recorded operation; or, store the recorded operation into a household gateway device; or, send the recorded operation to the terminal device through the household gateway device; or, send the recorded operation to a server through the household gateway device.

After that, when the terminal device needs to use the operation history, the terminal device may acquire the operation history.

In actual implementation, the manner for the terminal device to acquire the operation history may include at least one of the following manners.

The first manner is that when the operation history is stored in the terminal device, the terminal device may directly read the pre-stored operation history.

The second manner is that when the operation history is stored in the household appliance, the terminal device sends a third acquisition request for acquiring the operation history to the household appliance; and the household appliance sends the operation history to the terminal device after receiving the third acquisition request.

The third manner is that when the operation history is stored in the server, the terminal device sends a fourth acquisition request for acquiring the operation history to the server; and the server forwards the operation history to the terminal device after receiving the fourth acquisition request.

The fourth manner is that when the operation history is stored in the household gateway device, the terminal device may send a fifth acquisition request for acquiring the operation history to the household gateway device; and the household gateway device forwards the operation history to the terminal device after receiving the fifth acquisition request.

In step 502, the terminal device detects whether a habitual task exists according to the operation history, the habitual task being a task corresponding to an operation which has been received at a fixed time for more than a predetermined number of times.

After acquiring the operation history, the terminal device may detect whether the habitual task exists according to the operation history. This step is similar to the step 302 in the embodiment, which will not be elaborated herein in the embodiment.

In step 503, if the habitual task exists, then the terminal device displays first query information, the first query information being configured to query whether or not to set up a habitual task item corresponding to the fixed time.

Different from the above-mentioned embodiments, in the present embodiment, since the method is applied in the terminal device, the terminal device may directly display the first query information when the detection result of the terminal device shows that the habitual task exists, wherein the first query information is configured to query whether to set up the habitual task item corresponding to the fixed time.

In step 504, the terminal device receives a confirmation signal, and sets up the habitual task item corresponding to the fixed time after receiving the confirmation signal.

When the user views the first query information displayed by the terminal device and agrees to set up the habitual task item, the user may exert a confirmation signal. Accordingly, the terminal device receives the confirmation signal.

After the terminal device receives the confirmation signal, the terminal device may set up the habitual task item corresponding to the fixed time.

When the user rejects to set up the habitual task item, the user may exert a rejection signal. Accordingly, the terminal device receives the rejection signal, and ends the flow after receiving the rejection signal.

In step 505, the terminal device runs the habitual task according to the habitual task item at the fixed time.

After the terminal device sets up the habitual task item corresponding to the fixed time, when the fixed time arrives, the terminal device may send a control instruction of controlling the household appliance to run the habitual task to the household appliance. Accordingly, the household appliance may receive the control instruction, and run the habitual task after receiving the control instruction.

It should be illustrated that the present embodiment only takes the terminal device sending the control instruction to the household appliance at the fixed time as an example. In actual implementation, the terminal device may also directly send the control instruction carrying the fixed time to the household appliance without waiting for the arrival of the fixed time after setting up the habitual task item, which will not be limited in the embodiment.

In conclusion, through acquiring the operation history of the user for operating the household appliance, detecting whether the habitual task exists according to the operation history, the habitual task being the task corresponding to the operation which has been received at a fixed time for more than a predetermined number of times; and if the habitual task exists, setting up the habitual task item corresponding to the fixed time, the habitual task item being the task item for the household appliance to run the habitual task at the fixed time; the method for setting up a task provided by the present disclosure solves the problem in the related art that the household appliance may not provide timely services for the user; and achieves the effects that the household appliance may run the habitual task at the fixed time, so that the household appliance can always provide services required by the user.

According to the present embodiment, before setting up the habitual task item corresponding to the fixed time, a query about whether to set up the habitual task item corresponding to the fixed time is displayed, and after a confirmation signal is received, the habitual task item corresponding to the fixed time is set up. Therefore, the operation of the household appliance better meets the using habit of the user, thus improving the user experience.

Meanwhile, after setting up the habitual task item, when the fixed time arrives, the terminal device may control the household appliance to run the habitual task, thus solving the problem in the related art that when the user forgets to operate the household appliance, the household appliance will not run any task.

It should be additionally noted that in the foregoing embodiment, the method for setting up a task may also include the following steps.

Firstly, the terminal device acquires preset information, the preset information including at least one of air quality information of an environment in which the household appliance is located, a light intensity of the environment in which the household appliance is located within a first predetermined time period, a sound intensity of the environment in which the household appliance is located within a second predetermined time period and the last using time of the household appliance and/or other household appliance in the same LAN as that of the household appliance.

When the preset information includes the air quality information, the terminal device may acquire the air quality information from the household appliance capable of detecting the air quality and is connected with the household gateway device through a household gateway device.

When the preset information includes the light intensity of the environment in which the household appliance is located within the first predetermined time period, since the household appliance capable of acquiring the light intensity may acquire the light intensity of the environment in which the household appliance is located within the first predetermined time period, the terminal device may acquire the light intensity of the environment in which the household appliance is located within the first predetermined time period from the household appliance capable of acquiring the light intensity and is connected with the household gateway device through the household gateway device.

When the preset information includes the sound intensity of the environment in which the household appliance is located within the second predetermined time period, since the household appliance capable of acquiring the sound intensity may acquire the sound intensity of the environment in which the household appliance is located within the second predetermined time period, the terminal device may acquire the sound intensity of the environment in which the household appliance is located within the second predetermined time period from the household appliance capable of acquiring the sound intensity and is connected with the household gateway device through the household gateway device. The second predetermined time period and the first predetermined time period may either be identical time period, or different time periods, which will not be limited in the embodiment.

When the preset information includes the last using time of the household appliance and/or other household appliance in the same LAN as that of the household appliance, the terminal device may acquire the last using time of each household appliance connected with the household gateway device through the household gateway device.

Secondly, the terminal device detects whether the preset information satisfies a preset condition, the preset condition including at least one of the air quality information representing that the air quality being poorer than a preset air quality, the light intensity being less than a preset light intensity, the sound intensity being less than a preset intensity, and the last using time being a time before a predetermined duration.

This is similar to the corresponding steps in the foregoing embodiment, which will not be elaborated herein in the embodiment.

It should be illustrated that the embodiment only takes the foregoing four types of the preset information as an example. In actual implementation, the preset information may also include other information, which will not be limited in the embodiment. Moreover, when the preset information includes two or more than two types of information, it may be set that only when the two or more than two types of information satisfy the corresponding condition at the same time, the preset information satisfies the preset condition. Alternatively, it may be set that when the number of the two or more than two types of the information satisfying the conditions reaches a predetermined number, the preset information satisfies the preset condition.

Thirdly, if the preset information satisfies the preset condition, then the terminal device turns off the household appliance and other household appliance in the same LAN as that of the household appliance through the household gateway device.

If the detection result of the terminal device shows that the preset information satisfies the preset condition, it indicates that the user may possibly go out. Then, for the purpose of safety use of electricity and energy saving, the terminal device may turn off each household appliance connected with the household gateway device through the household gateway device.

In actual implementation, before turning off each household appliance connected with the household gateway device through the household gateway device, the terminal device may also display third query information, the third query information being configured to query whether or not to turn off each household appliance; if the terminal device receives a confirmation signal, then each household appliance is turned off; otherwise, the household appliance is not turned off. In this way, the operation of each household appliance better meets the using habit of the user, thus improving the user experience.

Embodiments of devices of the present disclosure are described hereinafter, which may be used for running embodiments of methods of the present disclosure. For the details not described in the embodiments of devices of the present disclosure, please refer to the embodiments of methods of the present disclosure.

FIG. 6 is a block diagram of an apparatus for setting up a task, according to an exemplary embodiment. The apparatus may be applied in a househould appliance, a terminal device or a server. As shown in FIG. 6, the apparatus for setting up a task may include: an operation record acquisition module 610, a task detection module 620 and a task item setting module 630.

The operation record acquisition module 610 is configured to acquire an operation history of a user for operating a household appliance.

The task detection module 620 is configured to detect whether a habitual task exists according to the operation history acquired by the operation record acquisition module 610, the habitual task being a task corresponding to an operation which has been received at a fixed time for more than a predetermined number of times.

The task item setting module 630 is configured to, when the detection result of the task detection module 620 is that the habitual task exists, set up a habitual task item corresponding to the fixed time, the habitual task item being a task item for the household appliance to run the habitual task at the fixed time.

In conclusion, through acquiring the operation history of the user for operating the household appliance, detecting whether the habitual task exists according to the operation history, the habitual task being the task corresponding to the operation which has been received at a fixed time for more than a predetermined number of times; and if the habitual task exists, setting up the habitual task item corresponding to the fixed time, the habitual task item being the task item for the household appliance to run the habitual task at the fixed time; the device for setting up a task provided by the present disclosure solves the problem in the related art that the household appliance may not provide timely services for the user; and achieves the effects that the household appliance may run the habitual task at the fixed time, so that the household appliance can always provide services required by the user.

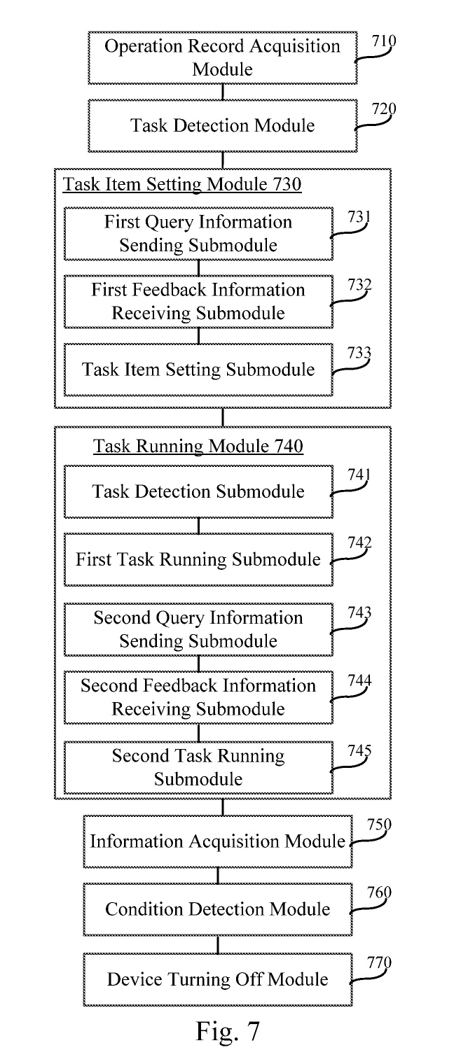

FIG. 7 is a block diagram of an apparatus for setting up a task, according to an exemplary embodiment. The apparatus may be applied in a household appliance. As shown in FIG. 7, the apparatus for setting up a task may include: an operation record acquisition module 710, a task detection module 720 and a task item setting module 730.

The operation record acquisition module 710 is configured to acquire an operation history of a user for operating a household appliance.

The task detection module 720 is configured to detect whether a habitual task exists according to the operation history acquired by the operation record acquisition module 710, the habitual task being a task corresponding to an operation which has been received at a fixed time for more than a predetermined number of times.

The task item setting module 730 is configured to, when the detection result of the task detection module 720 is that the habitual task exists, set up a habitual task item corresponding to the fixed time, the habitual task item being a task item for the household appliance to run the habitual task at the fixed time.

Optionally, the task item setting module 730 includes: a first query information sending submodule 731 configured to sent first query information to a terminal device, the first query information being configured to query whether to set up a habitual task item corresponding to the fixed time; a first feedback information receiving submodule 732 configured to receive first feedback information sent by the terminal device; and a task item setting submodule 733 configured to, when the first feedback information received by the first feedback information receiving submodule 732 represents confirmation, set up the habitual task item corresponding to the fixed time.

Optionally, the device further includes: a task running module 740 configured to run the habitual task according to the habitual task item at the fixed time.

Optionally, the task running module 740 includes: a task detection submodule 741 configured to detect whether the household appliance has already run the habitual task at the fixed time; and a first task running submodule 742 configured to run the habitual task when the detection result of the task detection submodule 741 is that the household appliance has not run the habitual task.

Optionally, the task running module 740 includes: a second query information sending submodule 743 configured to, when the fixed time arrives, send second query information to the terminal device, the second query information being configured to query whether or not to allow the household appliance running the habitual task; a second feedback information receiving submodule 744 configured to receive second feedback information sent by the terminal device; and a second task running submodule 745 configured to, when the second feedback information received by the second feedback information receiving submodule 744 represents allowing running, run the habitual task.

Optionally, the task running module 740 is configured to, when the habitual task is stored in the terminal device, a household gateway device or a server and when the fixed time arrives, send a control instruction of controlling the household appliance to run the habitual task by the terminal device, the household appliance or the server.

Optionally, the device further includes: an information acquisition module 750 configured to acquire preset information, the preset information including at least one of air quality information of an environment in which the household appliance is located, a light intensity of the environment in which the household appliance is located within a first predetermined time period, a sound intensity of the environment in which the household appliance is located within a second predetermined time period and the last using time of the household appliance and/or other household appliance in the same LAN as that of the household appliance; a condition detection module 760 configured to detect whether the preset information satisfies a preset condition, the preset condition including at least one of the air quality information representing that the air quality being poorer than a preset air quality, the light intensity being less than a preset light intensity, the sound intensity being less than a preset intensity, and the last using time being a time before a predetermined duration; and a device turning off module 770 configured to, when the detection result of the condition detection module 760 is that the preset information satisfies the preset condition, turn off the household appliance and other household appliance in the same LAN as that of the household appliance through the household gateway device.

In conclusion, through acquiring the operation history of the user for operating the household appliance, detecting whether the habitual task exists according to the operation history, the habitual task being the task corresponding to the operation which has been received at a fixed time for more than a predetermined number of times; and if the habitual task exists, setting up the habitual task item corresponding to the fixed time, the habitual task item being the task item for the household appliance to run the habitual task at the fixed time; the device for setting up a task provided by the present disclosure solves the problem in the related art that the household appliance may not provide timely services for the user; and achieves the effects that the household appliance may run the habitual task at the fixed time, so that the household appliance can always provide services required by the user.

According to the embodiment, the first query information is sent to the terminal device, and only when the received feedback information represents confirmation, i.e., the user agrees to set up the habitual task item at the fixed time, the household appliance may set up the habitual task item at the fixed time; therefore, the operation of the household appliance better meets the expectation of the user, thus improving the user experience.

Meanwhile, after setting up the habitual task item, when the fixed time arrives, the household appliance may run the habitual task, thus solving the problem in the related art that the household appliance will not run any task when the user forgets to operate the household appliance.

With respect to the apparatuses in the above embodiments, the specific manners for running operations for individual modules therein have been described in detail in the embodiments regarding the methods, which will not be elaborated herein.

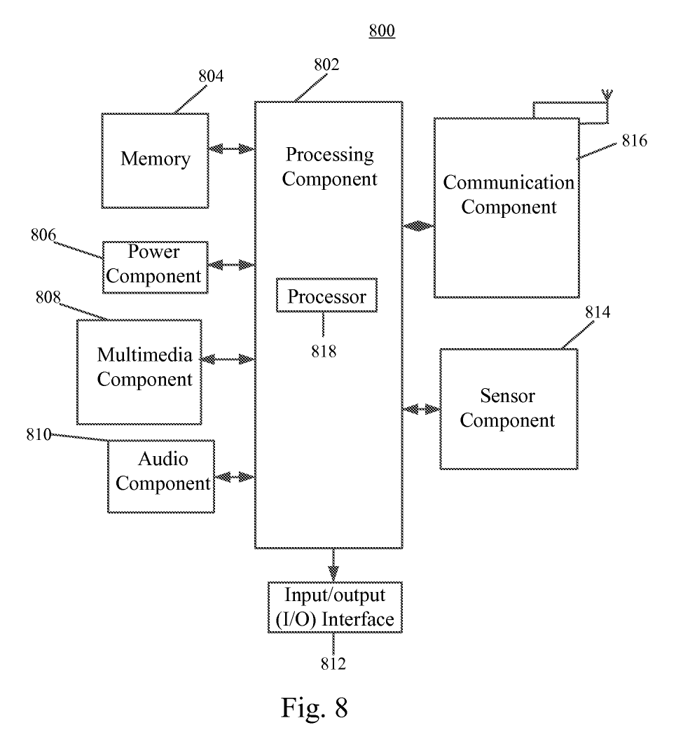

FIG. 8 is a block diagram of a terminal device 800 for setting up a task, according to an exemplary embodiment. For example, the terminal device 800 may be a mobile phone, a computer, a digital broadcast terminal, a messaging device, a gaming console, a tablet, a medical device, an exercise equipment, a personal digital assistant, and the like.

Referring to FIG. 8, the terminal device 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the terminal device 800, such as the operations associated with display, telephone calls, data communications, camera operations, and recording operations. The processing component 802 may include one or more processors 818 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the terminal device 800. Examples of such data include instructions for any applications or methods operated on the terminal device 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the terminal device 800. The power component 806 may include a power management system, one or more power sources, and any other components associated with the generation, management, and distribution of power in the terminal device 800.

The multimedia component 808 includes a screen providing an output interface between the terminal device 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and/or the rear camera may receive an external multimedia datum while the terminal device 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (“MIC”) configured to receive an external audio signal when the terminal device 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the terminal device 800. For instance, the sensor component 814 may detect an power-on/power-off status of the terminal device 800, relative positioning of components, e.g., the display and the keypad, of the terminal device 800, a change in position of the terminal device 800 or a component of the terminal device 800, a presence or absence of user contact with the terminal device 800, an orientation or an acceleration/deceleration of the terminal device 800, and a change in temperature of the terminal device 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the terminal device 800 and other devices. The terminal device 800 can access a wireless network based on a communication standard, such as WiFi, 2G, or 3G, or a combination thereof. In one exemplary embodiment, the communication component 816 receives a broadcast signal or broadcast associated information from an external broadcast management system via a broadcast channel. In one exemplary embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the terminal device 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer readable storage medium including instructions, such as included in the memory 804, executable by the processor 818 in the terminal device 800, for performing the above-described methods. For example, the non-transitory computer-readable storage medium may be a ROM, a RAM, a CD-ROM, a magnetic tape, a floppy disc, an optical data storage device, and the like.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

What is claimed is:

1. A method for setting up a task, comprising:
acquiring an operation history of a user for operating a household appliance;
detecting whether a habitual task exists according to the operation history, wherein the habitual task is a task corresponding to an operation which has been received at a fixed time for more than a predetermined number of times; and
if the habitual task exists, setting up a habitual task item corresponding to the fixed time, wherein the habitual task item is a task item for the household appliance to run the habitual task at the fixed time.

2. The method according to claim 1, wherein setting up the habitual task item corresponding to the fixed time comprises:
sending first query information to a terminal device, wherein the first query information is configured to query whether to set up the habitual task item corresponding to the fixed time;
receiving first feedback information sent by the terminal device; and
when the first feedback information represents confirmation, setting up the habitual task item corresponding to the fixed time.

3. The method according to claim 1, further comprising:
running the habitual task according to the habitual task item at the fixed time.

4. The method according to claim 2, further comprising:
running the habitual task according to the habitual task item at the fixed time.

5. The method according to claim 3, wherein running the habitual task according to the habitual task item at the fixed time comprises:
detecting whether the household appliance has already run the habitual task at the fixed time; and
running the habitual task if the household appliance does not run the habitual task.

6. The method according to claim 3, wherein running the habitual task according to the habitual task item at the fixed time comprises:
sending second query information to a terminal device at the fixed time, wherein the second query information is configured to query whether to allow the household appliance running the habitual task;
receiving second feedback information sent by the terminal device; and
when the second feedback information represents that the running is allowable, running the habitual task.

7. The method according to claim 3, wherein running the habitual task according to the habitual task item at the fixed time comprises:
when the habitual task is stored in a terminal device, a household gateway device or a server and when the fixed time arrives, sending, by the terminal device, the household appliance or the server, a control instruction of controlling the household appliance to run the habitual task to the household appliance.

8. The method according to claim 1, further comprising:
acquiring preset information, wherein the preset information includes at least one of air quality information of an environment in which the household appliance is located, a light intensity of the environment in which the household appliance is located within a first predetermined time period, a sound intensity of the environment in which the household appliance is located within a second predetermined time period and a last using time of the household appliance and/or other household appliance in the same LAN as that of the household appliance;
detecting whether the preset information satisfies a preset condition, wherein the preset condition includes at least one of the air quality information representing that the air quality is poorer than a preset air quality, the light intensity being less than a preset light intensity, the sound intensity being less than a preset intensity, and the last using time is a time before a predetermined duration; and
if the preset information satisfies the preset condition, turning off the household appliance and other household appliance in the same LAN as that of the household appliance through the household gateway device.

9. The method according to claim 2, further comprising:
acquiring preset information, wherein the preset information includes at least one of air quality information of an environment in which the household appliance is located, a light intensity of the environment in which the household appliance is located within a first predetermined time period, a sound intensity of the environment in which the household appliance is located within a second predetermined time period and a last using time of the household appliance and/or other household appliance in the same LAN as that of the household appliance;
detecting whether the preset information satisfies a preset condition, wherein the preset condition includes at least one of the air quality information representing that the air quality is poorer than a preset air quality, the light intensity being less than a preset light intensity, the sound intensity being less than a preset intensity, and the last using time is a time before a predetermined duration; and
if the preset information satisfies the preset condition, turning off the household appliance and other household appliance in the same LAN as that of the household appliance through the household gateway device.

10. A device for setting up a task, comprising:
a processor; and
a memory for storing instructions executable by the processor;
wherein the processor is configured to perform:
acquiring an operation history of a user for operating a household appliance;
detecting whether a habitual task exists according to the operation history, wherein the habitual task is a task corresponding to an operation which has been received at a fixed time for more than a predetermined number of times; and
if the habitual task exists, setting up a habitual task item corresponding to the fixed time, wherein the habitual task item is a task item for the household appliance to run the habitual task at the fixed time.

11. The device according to claim 10, wherein setting up the habitual task item corresponding to the fixed time comprises:
sending first query information to a terminal device, wherein the first query information is configured to query whether to set up the habitual task item corresponding to the fixed time;
receiving first feedback information sent by the terminal device; and
when the first feedback information represents confirmation, setting up the habitual task item corresponding to the fixed time.

12. The device according to claim 10, wherein the processor is further configured to perform:
running the habitual task according to the habitual task item at the fixed time.

13. The device according to claim 11, wherein the processor is further configured to perform:
running the habitual task according to the habitual task item at the fixed time.

14. The device according to claim 12, wherein running the habitual task according to the habitual task item at the fixed time comprises:
detecting whether the household appliance has already run the habitual task at the fixed time; and
running the habitual task if the household appliance does not run the habitual task.

15. The device according to claim 12, wherein running the habitual task according to the habitual task item at the fixed time comprises:
sending second query information to a terminal device at the fixed time, wherein the second query information is configured to query whether to allow the household appliance running the habitual task;
receiving second feedback information sent by the terminal device; and
when the second feedback information represents that the running is allowable, running the habitual task.

16. The device according to claim 12, wherein running the habitual task according to the habitual task item at the fixed time comprises:
when the habitual task is stored in a terminal device, a household gateway device or a server and when the fixed time arrives, sending, by the terminal device, the household appliance or the server, a control instruction of controlling the household appliance to run the habitual task to the household appliance.

17. The device according to claim 10, wherein the processor is further configured to perform:
acquiring preset information, wherein the preset information includes at least one of air quality information of an environment in which the household appliance is located, a light intensity of the environment in which the household appliance is located within a first predetermined time period, a sound intensity of the environment in which the household appliance is located within a second predetermined time period and a last using time of the household appliance and/or other household appliance in the same LAN as that of the household appliance;
detecting whether the preset information satisfies a preset condition, wherein the preset condition includes at least one of the air quality information representing that the air quality being poorer than a preset air quality, the light intensity being less than a preset light intensity, the sound intensity is less than a preset intensity, and the last using time is a time before a predetermined duration; and
if the preset information satisfies the preset condition, turning off the household appliance and other household appliance in the same LAN as that of the household appliance through the household gateway device.

18. The device according to claim 11, wherein the processor is further configured to perform:
acquiring preset information, wherein the preset information includes at least one of air quality information of an environment in which the household appliance is located, a light intensity of the environment in which the household appliance is located within a first predetermined time period, a sound intensity of the environment in which the household appliance is located within a second predetermined time period and a last using time of the household appliance and/or other household appliance in the same LAN as that of the household appliance;
detecting whether the preset information satisfies a preset condition, wherein the preset condition includes at least one of the air quality information representing that the air quality being poorer than a preset air quality, the light intensity being less than a preset light intensity, the sound intensity is less than a preset intensity, and the last using time is a time before a predetermined duration; and
if the preset information satisfies the preset condition, turning off the household appliance and other household appliance in the same LAN as that of the household appliance through the household gateway device.

19. A non-transitory readable storage medium comprising instructions, executable by a processor in a device, for performing a method for setting up a task, the method comprising:
acquiring an operation history of a user for operating a household appliance;
detecting whether a habitual task exists according to the operation history, wherein the habitual task is a task corresponding to an operation which has been received at a fixed time for more than a predetermined number of times; and
if the habitual task exists, setting up a habitual task item corresponding to the fixed time, wherein the habitual task item is a task item for the household appliance to run the habitual task at the fixed time.
